(19) United States
(12) Patent Application Publication
(10) Pub. No.: US 2024/0206473 A1
(43) Pub. Date: Jun. 27, 2024

(54) Zinc and Boron Containing Enhanced Wood Preservative

(71) Applicants: Ed NICHENKO, Morristown, NJ (US); Jayesh PATEL, Morristown, NJ (US); Susan THOMASON, Morristown, NJ (US); Jin LEHONG, Morristown, NJ (US); ARXADA, LLC, Morristown, NJ (US)

(72) Inventors: Ed Nichenko, McDonough, GA (US); Jayesh Patel, Stone Mountain, GA (US); Susan Thomason, Oxford, GA (US); Jin Lehong, Huntersville, NC (US)

(21) Appl. No.: 18/551,209

(22) PCT Filed: Mar. 18, 2022
(86) PCT No.: PCT/US2022/020956

§ 371 Date: Sep. 19, 2023

Related U.S. Application Data
(60) Provisional application No. 63/166,733, filed on Mar. 26, 2021.
(60) Provisional application No. 63/163,219, filed on Mar. 19, 2021.

(51) Int. Cl. A01N 59/20; A01N 43/653; A01N 59/14; A01P 3/00; B27K 3/22

(52) U.S. Cl. CPC A01N 59/20; A01N 43/653; A01N 59/14; A01P 3/00; B27K 3/22

(57) ABSTRACT

A wood preservative composition and a method of manufacturing a wood preservative composition that includes a copper containing biocide, a zinc containing biocide, a boron containing biocide, and an organic biocide are provided. The wood preservative composition exhibits improved biocidal efficacy against copper tolerant fungi.

### RELATED APPLICATIONS

The present application is based on and claims priority to U.S. Provisional Patent applications Ser. No. 63/163,219, filed on Mar. 19, 2021, and to Ser. No. 63/166,733, filed on Mar. 26, 2021, which are both incorporated herein by reference.

### BACKGROUND

Wood products and other cellulose-based products are subject to attack from various types of organisms, including molds, fungi, and insects, such as termites. Attacks by these organisms can cause the wood in wood and other cellulose-based products to decay, reducing the product's mass and structural integrity. In order to combat microorganism attack, many types of wood preservative treatments have been developed and exist on the market today. These wood preservative treatments can be applied directly to the surface, by dip, spray or brush, or by vacuum pressure immersion. During industrial application of preservatives, wood and wood-based and cellulose-based products is typically impregnated with the treatment solution to achieve either shell or full cell type penetration into the substrate. Depending on the wood species being treated and the end use, the depth of penetration of the preservative solution into the wood and other cellulose-based product can have a significant bearing on the useful service life of the treated wood and other cellulose-based product.

Copper-organic wood preservatives have been used successfully as ground contact preservatives around the world. However, there are fungi which have proved resistant to such compositions, and cause staining and degradation of wood containing copper based preservatives. Other types of biocidal metal compounds can also be used to treat wood, such as zinc. Although perhaps not as widespread in its use as copper, there are a number of commercially available wood preservatives which include zinc as a biocidal metal ion, either alone or in combination with copper. However, these existing compositions suffer from either (1) the zinc failing to properly control the copper resistant fungi, or (2) lacking sufficient efficacy against even non-copper resistant fungi when used together at the same active amount as copper alone, in addition to other problems.

Non-metal based alternatives such as azoles and boron based biocides have been used in combination with metal based preservatives in order to combat metal-tolerant fungi. However, azoles and boron based biocides, alone or in combination were found to demonstrate drawbacks, including leachability.

Azoles have been found to have limited efficacy against certain aggressive brown rot fungi except at very high concentrations that are unlikely in commercial use. Azoles and other organic biocides are known to have steep penetration gradients across a cross section of treated timber. The interior portion of the timber can exhibit very low concentrations of azole compared to the outer portions making the wood more susceptible to fungal attack.

Borates are very effective preservatives against a wide range of wood decay fungi. However, borate preservatives are generally soluble compounds subject to higher rates of leaching than metal-based preservatives.

Accordingly, there is a need for wood preservative compositions that offer enhanced biocidal efficacy. It would be a further benefit to provide a wood preservative composition that exhibits improved efficacy against copper tolerant fungi. Furthermore, it would be a benefit to provide a biocidal composition that exhibits prolonged efficacy against fungi, including copper-tolerant fungi and improved protection and penetration into the inner portions of the wood, wood-products and other cellulose-based products.

### SUMMARY

In general, the present disclosure is directed to a wood preservative composition. The wood preservative composition exhibits improved biocidal efficacy against copper tolerant fungi. The resulting wood preservative composition is suitable for the preservation of wood and other cellulose-based materials.

In one embodiment, the wood preservative composition comprises a copper containing biocide, a zinc containing biocide, a boron containing biocide, and an organic biocide. The copper containing biocide and the zinc containing biocide are present in the wood preservative composition such that a ratio of copper to zinc is from about 15:1 to about 1:5 based on weight. Additionally, the copper containing biocide and the boron containing biocide are present in the wood preservative composition such that a ratio of copper to boric acid equivalents is from about 15:1 to about 1:5 based on weight.

The copper containing biocide can comprise a basic copper carbonate, a copper oxide, or a combination thereof.

The copper containing biocide used in the invention can be used in micronized form, in dispersed form or complexed with an amino compound, when used in micronized form having a particle size of 0.01 microns to 25.0 microns. The particle size of the micronized copper biocide used in the composition disclosed herein can be between 0.01 to 10.0 microns, between 0.05 to 10 microns, between 0.1 to 10.0 microns, between 0.01 to 1.0 micron, between 0.05 to 1.0 microns, between 0.1 to 1.0 microns, between 0.2 to 1.0 microns. If a more uniform penetration is desired, particle size of the micronized copper biocide compound used in the composition disclosed herein can be between 0.05 to 1.0 microns.

The zinc containing biocide can comprise zinc oxide, zinc acetate, zinc borate or a combination of zinc oxide and zinc borate.

The zinc containing biocide used in the invention can be used in micronized form having a particle size 0.01 microns to 25.0 microns or complexed with an amino compound. The particle size of the micronized zinc biocide used in the composition disclosed herein can be between 0.01 to 10 microns, between 0.05 to 10 microns, between 0.01 to 1.0 microns, between 0.05 to 1.0 microns, between 0.1 to 1.0 microns, between 0.2 to 1.0 microns. If a more uniform penetration is desired, particle size of the micronized zinc biocide compound used in the composition disclosed herein can be between 0.05 to 1.0 microns.

The boron containing biocide can comprise boric acid, disodium tetraborate pentahydrate, disodium octaborate tetrahydrate, or a combination thereof.

The boron containing biocide can be boric acid.

The organic biocide is selected from a fungicide.

The organic biocide may be independently selected from the group consisting of azoles, quaternary ammonium compounds, isothiazolones, pyrazolecarboxamides, phenylpyrazoles, haloalkynyl compounds or a combination thereof.

The organic biocide used in the invention can be in micronized form having a particle size 0.01 microns to 25.0 microns. The particle size of the micronized organic biocide used in the composition disclosed herein can be between 0.01 to 10 microns, 0.05 to 10 microns, between 0.1 to 10.0 microns, between 0.01 to 1.0 micron, between 0.05 to 1.0 microns, between 0.1 to 1.0 microns, between 0.2 to 1.0 microns.

The organic biocide can be an azole.

The azole can be independently selected from then group consisting of imidazole, benzimidazole, triazole, or a combination thereof.

The organic biocide can be a 1,2,4-triazole.

The 1,2,4-triazole may be independently selected from the group consisting of cyproconazole, fenbuconazole, propiconazole, tebuconazole, triadimefon, triticonazole or a combination thereof.

The 1,2,4-triazole may be independently selected from the group consisting of tebuconazole or propiconazole or a combination thereof.

The 1,2,4-triazole may be selected from tebuconazole.

The 1,2,4-triazole may be selected from propiconazole.

The azole can be complexed with the copper containing biocide.

The azole used in the invention can be in micronized form having a particle size 0.01 microns to 25.0 microns. The particle size of the micronized azole used in the composition disclosed herein can be between 0.01 to 10 microns, 0.05 to 10 microns, between 0.1 to 10.0 microns, between 0.01 to 1.0 micron, between 0.05 to 1.0 microns, between 0.1 to 1.0 microns, between 0.2 to 1.0 microns. If a more uniform penetration is desired, particle size of the micronized azole compound used in the composition disclosed herein can be between 0.05 to 1.0 microns.

The organic biocide may be a quaternary ammonium compound.

The quaternary ammonium compound may be independently selected from the group consisting of didecyl dimethyl ammonium chloride, didecyl dimethyl ammonium carbonate, didecyl dimethyl ammonium bicarbonate and combinations thereof.

The organic biocide may be an isothiazolone.

The isothiazolone compound may be independently selected from the group consisting of 2-methyl-4-isothiazolin-3-one (MIT), 5-chloro-2-methyl-4-isothiazolin-3-one (CMIT), 4,5-dichloro-2n-octylisothiazolin-3-one (DCOIT), 5-chloro-2n-octyl-4-isothiazolin-3-one (COIT), 2-octyl-2H-isothiazolin-3-one (OIT), 1,2-benzothiazolin-3-one (BIT), N-methyl-1,2-benzisothiazolin-3-one (MBIT), or 2-butyl-1,2-benzisothiazolin-3(2H)-one (BBIT) or combinations thereof.

The isothiazolone compound may be 4,5-dichloro-2n-octylisothiazolin-3-one (DCOIT).

The organic biocide may be a pyrazolecarboxamide.

The pyrazolecarboxamide may be penflufen.

The organic biocide may be a phenylpyrazole.

The organic biocide may be an haloalkynyl compound.

The haloalkynyl compound may be 3-iodo-2-propynyl butyl carbamate (IPBC).

The organic biocide can be complexed with the copper containing biocide.

The copper containing biocide may comprise a basic copper carbonate, the zinc containing biocide may comprise a zinc oxide or a combination of a zinc oxide and zinc borate, the boron containing biocide may comprise a boric acid, and the organic biocide can be selected from the group consisting of azoles, quaternary ammonium compounds, isothiazolones, pyrazolecarboxamides, phenylpyrazoles, haloalkynyl compounds or a combination thereof.

The copper containing biocide can constitute from about 0.1 wt % to about 75 wt % of the composition, the zinc containing biocide can constitute from about 0.1 wt % to about 50 wt % of the composition, the boron containing biocide can constitute from about 0.1 wt % to about 75 wt % of the composition, and the organic biocide can constitute from about 0.1 wt % to about 20 wt % of the composition based on the total weigh of the composition.

The copper containing biocide may comprise a basic copper carbonate, the zinc containing biocide may comprise a zinc oxide or a combination of a zinc oxide and zinc borate, the boron containing biocide may comprise a boric acid, and the organic biocide may comprise an azole.

The copper containing biocide may comprise a basic copper carbonate, the zinc containing biocide may comprise a zinc oxide or a combination of a zinc oxide and zinc borate, the boron containing biocide may comprise a boric acid, and azole can be independently selected from the group consisting of tebuconazole or propiconazole or a combination thereof.

The copper containing biocide may comprise a basic copper carbonate, the zinc containing biocide may comprise a zinc oxide or a combination of a zinc oxide and zinc borate, the boron containing biocide may comprise a boric acid, and the azole may comprise tebuconazole.

The copper containing biocide can constitute from about 0.1 wt % to about 75 wt % of the composition, the zinc containing biocide can constitute from about 0.1 wt % to about 50 wt % of the composition, the boron containing biocide can constitute from about 0.1 wt % to about 75 wt % of the composition, and the azole can constitute from about 0.1 wt % to about 20 wt % of the composition based on the total weigh of the composition.

The copper containing biocide may comprise a basic copper carbonate, the zinc containing biocide may comprise a zinc oxide or a combination of a zinc oxide and zinc borate, the boron containing biocide may comprise a boric acid, and the organic biocide may comprise an pyrazolecarboxamide.

The copper containing biocide may comprise a basic copper carbonate, the zinc containing biocide may comprise a zinc oxide or a combination of a zinc oxide and zinc borate, the boron containing biocide may comprise a boric acid, and the pyrazolecarboxamide can be independently selected from, penflufen.

The copper containing biocide may comprise a basic copper carbonate, the zinc containing biocide may comprise a zinc oxide or a combination of a zinc oxide and zinc borate, the boron containing biocide may comprise a boric acid, and the pyrazolecarboxamide may comprise penflufen.

In one embodiment, the copper containing biocide can constitute from about 0.1 wt % to about 75 wt % of the composition, the zinc containing biocide can constitute from about 0.1 wt % to about 50 wt % of the composition, the boron containing biocide can constitute from about 0.1 wt % to about 75 wt % of the composition, and the pyrazolecarboxamide can constitute from about 0.1 wt % to about 20 wt % of the composition based on the total weigh of the composition

In one embodiment the copper containing biocide may comprise a basic copper carbonate, the zinc containing biocide may comprise a zinc oxide or a combination of a zinc oxide and zinc borate, the boron containing biocide may comprise a boric acid, and the organic biocide may comprise a quaternary ammonium compound.

In one embodiment the copper containing biocide may comprise a basic copper carbonate, the zinc containing biocide may comprise a zinc oxide or a combination of a zinc oxide and zinc borate, the boron containing biocide may comprise a boric acid, and the quaternary ammonium compound can be independently selected from the group consisting of didecyl dimethyl ammonium chloride, didecyl dimethyl ammonium carbonate, didecyl dimethyl ammonium bicarbonate or a combination thereof.

In one embodiment, the copper containing biocide can constitute from about 0.1 wt % to about 75 wt % of the composition, the zinc containing biocide can constitute from about 0.1 wt % to about 50 wt % of the composition, the boron containing biocide can constitute from about 0.1 wt % to about 75 wt % of the composition, and the quaternary ammonium compound can constitute from about 0.1 wt % to about 20 wt % of the composition based on the total weigh of the composition

In one embodiment the copper containing biocide may comprise a basic copper carbonate, the zinc containing biocide may comprise a zinc oxide or a combination of a zinc oxide and zinc borate, the boron containing biocide may comprise a boric acid, and the organic biocide may comprise an isothiazolone.

In one embodiment the copper containing biocide may comprise a basic copper carbonate, the zinc containing biocide may comprise a zinc oxide or a combination of a zinc oxide and zinc borate, the boron containing biocide may comprise a boric acid, and the isothiazolone can be independently selected from the group comprising 2-methyl-4-isothiazolin-3-one (MIT), 5-chloro-2-methyl-4-isothiazolin-3-one (CMIT), 4,5-dichloro-2n-octylisothiazolin-3-one (DCOIT), 5-chloro-2n-octyl-4-isothiazolin-3-one (COIT), 4,5-dichloro-2-cyclohexyl-4-isothiazolin-3-one, 2-octyl-2H-isothiazolin-3-one (OIT), 1,2-benzothiazolin-3-one (BIT), N-methyl-1,2-benzisothiazolin-3-one (MBIT), or 2-butyl-1,2-benzisothiazolin-3(2H)-one (BBIT) or combinations thereof.

In one embodiment, the copper containing biocide can constitute from about 0.1 wt % to about 75 wt % of the composition, the zinc containing biocide can constitute from about 0.1 wt % to about 50 wt % of the composition, the boron containing biocide can constitute from about 0.1 wt % to about 75 wt % of the composition, and the isothiazolione can constitute from about 0.1 wt % to about 20 wt % of the composition based on the total weigh of the composition.

In one embodiment the copper containing biocide may comprise a basic copper carbonate, the zinc containing biocide may comprise a zinc oxide or a combination of a zinc oxide and zinc borate, the boron containing biocide may comprise a boric acid, and the organic biocide may comprise a haloalkylnyl compound.

In one embodiment the copper containing biocide may comprise a basic copper carbonate, the zinc containing biocide may comprise a zinc oxide or a combination of a zinc oxide and zinc borate, the boron containing biocide may comprise a boric acid, and the haloalkylnyl compound may comprise 3-iodo-2-propynyl butyl carbamate (IPBC).

In one embodiment, the copper containing biocide can constitute from about 0.1 wt % to about 75 wt % of the composition, the zinc containing biocide can constitute from about 0.1 wt % to about 50 wt % of the composition, the boron containing biocide can constitute from about 0.1 wt % to about 75 wt % of the composition, and the haloalkylnyl compound can constitute from about 0.1 wt % to about 20 wt % of the composition based on the total weigh of the composition.

In one embodiment the composition can have a pH of from about 3 to about 10.

In one embodiment the composition can further include an alkanolamine.

In one embodiment the copper containing biocide and the zinc containing biocide can be present in the wood preservative composition such that ratio of copper to zinc is from about 15:1 to about 1:5, from 15:1 to about 1:1, from 10:1 to about 1:5, from 10:1 to about 1:2, from 10:1 to about 1:1, based on weight.

In one embodiment the copper containing biocide and the boron containing biocide can be present in the wood preservative composition such that a ratio of copper to boric acid equivalents is from about 15:1 to about 1:5, from 15:1 to about 1:1, from 10:1 to about 1:5, from 10:1 to about 1:2, from 10:1 to about 1:1, based on weight.

In one embodiment the zinc containing biocide and the boron containing biocide can be present in the wood preservative composition such that a ratio of zinc to boric acid equivalents is from about 5:1 to about 1:5, from about 3:1 to about 1:1.5 based on weight.

Wood and other cellulose-based products can be treated with any of the wood preservative composition described. In the wood and other cellulose-based product, the copper can be present in an amount from about 200 g/m³ (gram per cubic metre) to about 7.5 kg/m³ (kilogram per cubic metre), the zinc can be present in an amount from about 40 g/m³ to about 1.5 kg/m³, the boric acid equivalents can be present in an amount from about 40 g/m³ to about 3 kg/m³, and the organic biocide can be present in an amount from about 20 g/m³ to about 260 g/m³ of the wood based product.

In one embodiment a wood preservative composition includes a copper containing biocide, a zinc containing biocide, a boron containing biocide including boric acid, and an azole. The copper containing biocide and the zinc containing biocide are present in the wood preservative composition such that a ratio of copper to zinc is from about 15:1 to about 1:5 based on weight. The copper containing biocide and the boron containing biocide are present in the wood preservative composition such that a ratio of copper to boric acid equivalents is from about 15:1 to about 1:5 based on weight. The copper containing biocide includes a basic copper carbonate. The zinc containing biocide comprises a zinc oxide or a combination of a zinc oxide and zinc borate. The boron containing biocide comprises a boric acid. The azole comprises a tebuconazole.

The invention further provides a method of treating wood with any of the wood preservative compositions disclosed. In the method, the copper containing biocide, the zinc containing biocide, the boron containing biocide, and the organic biocide can be injected into the wood in a one-step process.

The method for manufacturing a wood preservative composition is described. The method includes dispersing at least a portion of a copper containing biocide and a zinc containing biocide, micronizing at least one organic biocide to produce a micronized organic biocide, and combining a boron containing biocide including boric acid with the copper containing biocide, the zinc containing biocide, and the micronized organic biocide. The copper containing biocide and the zinc containing biocide are present in the wood preservative composition such that a ratio of copper to zinc is from about 15:1 to about 1:5 based on weight. Additionally, the copper containing biocide and the boron containing biocide are present in the wood preservative composition such that a ratio of copper to boric acid equivalents is from about 15:1 to about 1:5 based on weight.

The copper containing biocide and the zinc containing biocide can be milled with at least one dispersant.

The copper containing biocide can constitute from about 1 wt % to about 75 wt % of the composition, the zinc containing biocide can constitute from about 0.1 wt % to about 50 wt % of the composition, the boron containing biocide can constitute from about 0.1 wt % to about 75 wt % of the composition, and the organic biocide can constitute from about 0.1 wt % to about 20 wt % of the composition based on the total weight of the composition.

The copper containing biocide may comprise a basic copper carbonate, the zinc containing biocide may comprise a zinc oxide or a combination of a zinc oxide and a zinc borate, the boron containing biocide may comprise a boric acid, and the azole may comprise a tebuconazole.

Each of the embodiments recited above may be combined with one or more of the other embodiments recited above in certain embodiments.

These and other features, embodiments and advantages of the present invention will become better understood with reference to the following description and appended claims. The accompanying drawings, which are incorporated in and constitute a part of this specification, illustrate embodiments of the invention and, together with the description, serve to explain the principles of the invention.

### DEFINITIONS

As used herein, the term “D50” or “D50 particle size” refers to the volume median particle size, where 50% of the particles of the sample volume have a size below that range or value.

Analogously, as used herein, the term “D95” or “D95 particle size” refers to a value where 99% of the particles of the sample volume have a size below that range or value.

As used herein, the term “particle size” as used herein, unless specifically stated otherwise, refers to the median particle size D50.

The terms “median particle size” and “average particle size” and D50 are used herein interchangeably.

As used herein, the term “micronized” as used herein means a median particle size (D50) in the range of 0.01 to 25 microns.

The terms “micron” and “micrometre” are used herein interchangeably.

As used herein, the term “preservative” as used herein means a composition that renders the material to which it is applied more resistant to insect, fungal and microbial attack than the same material without having the composition applied.

As used herein, the term “wood” refers to wood and other cellulose-based products. The term “wood”, “timber” and “wood products” are used interchangeably.

As used herein, the term “cellule-based wood product” includes wood: wood products such as composite wood products (Oriented Strand Board, particle board, plywood, laminated veneer lumber (LVL) and other laminated wood products, etc.): paper and paper products: textiles having a cellulose component: rope and other products containing cellulose fiber, etc.

As used herein, the term “boron containing biocide” unless specifically stated otherwise, is intended to refer to compounds which contain the element boron, such as, for example, boron-containing minerals, borate compounds, boron ester compounds, and other organic or inorganic boron-containing compounds.

As used herein, the ratio of copper to zinc based on weight is calculated based on the copper content in any copper compound and the zinc content in any zinc compound in order to make comparison of the obtained results possible.

As used herein, the ratio of copper to boric acid equivalent (BAE) based on weight is calculated based on the copper content in any copper-compound and the BAE content in any boron compound in order to make comparison of the obtained results possible.

As used herein, the ratio of zinc to boric acid equivalent (BAE) based on weight is calculated based on the zinc content in any zinc compound and the BAE content in any boron compound in order to make comparison of the obtained results possible.

As used herein, the term “boric acid equivalent” refers to the amount of boron converted to boric acid equivalent (BAE) in order to make comparison of the obtained results possible. The boron containing biocides can contain different levels of boron. For comparing different boron containing biocides, the amount of boron was converted to boric acid equivalent (BAE). In the following examples, boric acid equivalent (BAE) was calculated using the following conversion factors:

| boron | | | | | disodium | |
|---|---|---|---|---|---|---|
| containing | | | boric | | octaborate | zinc |
| biocide | boron | B₂O₃ | acid | borax | tetrahydrate | borate |
| BAE | 5.721 | 1.1776 | 1.000 | 0.646 | 1.199 | 0.852 |

For example, if borax is retained in a wood block at a concentration of 1,000 ppm, the boric acid equivalent is 1,000 ppm*0.646=646 ppm.

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values there between. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

### DETAILED DESCRIPTION

The present disclosure is directed to an unexpectedly synergistic combination of a copper containing biocide, a zinc containing biocide, a boron containing biocide and at least one organic biocide that provides a highly effective wood preservation composition. Surprisingly, the wood preservative composition prepared by the present disclosure display significant synergy between the active components which provide for improved biocidal efficacy against copper tolerant fungi even at the same, or similar total metal-based biocide concentrations.

Additionally, the present disclosure has found that, when the disclosed compositions are utilized in the treatment of wood or wood-based products, the resulting wood or wood-based product exhibits improved properties over copper tolerant fungi, as well as improved longer term protection, both in the core and outer layers of the wood or wood-based product.

The wood preservative compositions of the present invention can be used against a broad spectrum of wood decay fungi. Typical wood decay fungi include brown rot fungi, white rot fungi, and soft rot fungi. Examples of brown rot fungi are Coniophora puteana, Serpula lacrymans, Fibroporia radiculosa, Fibroporia vaillantii, Fomitopsis palustri, Gloeophyllum trabeum, Gleoeophyllum sepiarium, Lentinum lepideus, Oligoporus placenta, Meruliporia incrassate, Daedalea quercina, Postia placenta, Phaeolus schweinitzii, and Fomitopsis pinicola. Examples of white rot fungi are Trametes versicolor, Phanerochaete chrysosporium. Pleurotus ostreatus, Schizophyllum commune, Irpex lacteus. Examples of white rot fungi are Chaetomium globosum, Lecythophora hoffinannii, Monodictys putredinis, Humicola alopallonella, Cephalosporium, Acremonium, and Chaetomium.

Further the present disclosure has found that by incorporating specific amounts of a boron containing biocide and a zinc containing biocide in relation to the biocidal metal (copper), a synergistic effect can be exhibited, combatting fungi, including copper tolerant fungi, resulting in more robust preservation, as well as longer term preservation, than previously exhibited by a biocide containing any one or more of the above components alone, or in amounts outside of the ratios of the present disclosure. For instance, the copper containing biocide and the zinc containing biocide may be present in the preservative composition in an amount such that a weight ratio of copper to zinc of about 15:1 to about 1:5 is provided in the preservative composition, such as about 12.5:1 to about 2:1, such as about 10:1 to about 3:1, such as about 9:1 to about 4:1, such as about 8:1 to about 5:1, 15:1 to about 1:5, from 15:1 to about 1:1, from 10:1 to about 1:5, from 10:1 to about 1:2, from 10:1 to about 1:1, based on weight or any ranges or values therebetween.

Similarly, the copper containing biocide and the boron containing biocide may be present in the preservative composition in an amount such that a ratio of copper to boron containing biocide, expressed as boric acid equivalents, of about 15:1 to about 1:5 is provided in the preservative composition, such as about 12.5:1 to about 1.5:1, such as about 10:1 to about 2:1, such as about 9:1 to about 3:1, such as about 8:1 to about 4:1, 15:1 to about 1:5, from 15:1 to about 1:1, from 10:1 to about 1:5, from 10:1 to about 1:2, from 10:1 to about 1:1, based on weight or any ranges or values therebetween. Particularly, as discussed above, the present disclosure has found that by supplementing the copper containing biocide with zinc containing biocide and boron containing biocide, excellent protection against fungi, including copper-tolerant fungi, is exhibited.

For instance, the present disclosure has found that the sum of the fractional inhibitory concentrations of the composition containing the copper containing biocide, zinc containing biocide, boron containing biocide, and an azole in the above ratios may be less than 1 (one) when tested against a target microorganism, particularly against brown rot fungi. The fractional inhibitory concentration is calculated as the concentration of a biocide which controlled growth in a mixture divided by the amount of biocide required to control growth when used alone. Particularly, here, the fractional inhibitory concentration is calculated against an amount of a composition containing copper and azole alone needed to control growth of a copper resistant fungi, Fibroporia radiculosa. The fractional inhibitory concentration of a biocide can be calculated by dividing the concentration of the biocide attributable to antimicrobial activity in a mixture of the copper containing biocide, zinc containing biocide, boron containing biocide, and azole divided by the minimum inhibitory concentration of the combination of copper containing biocide and azole when tested against the target microorganism. The minimum inhibitory concentration is the lowest concentration of biocide which showed growth inhibition when used alone. In accordance with the present disclosure, when targeting a particular microorganism, the sum of the fractional inhibitory concentrations of the first biocide and the second biocide, when used in combination with the zinc and boron can be less than about 0.9, such as less than about 0.8, such as less than about 0.7, which will be discussed in greater detail in the examples below. As known in the art, any value less than 1 (one) indicates synergistic interactions.

While the copper containing biocide can include any biocidal copper compound providing the above recited ratio of copper, the copper containing biocide may be incorporated into the composition in the form of inorganic copper salts, such as carbonate, bicarbonate, sulfate, nitrate, chloride, hydroxide, borate, fluoride or oxide.

The copper containing biocides used in the composition of the present invention are known and include but are not limited to, for example copper hydroxide, copper(I)oxide, copper(II)oxide, copper carbonate, basic copper carbonate, copper sulfate, basic copper sulfate, copper acetate, copper borate, copper citrate, copper chloride, copper hydroxide, copper oxychloride, copper oleate, copper silicate, copper 8-hydroxyquinolate, copper dimethyldithiocarbamate, copper omadine, copper naphthenate, cufraneb or tricopper dichloride dimethyldithiocarbamate, copper salts of fatty and rosin acids, copper ethylenediaminetetraacetate, and copper thiocyanate.

Alternatively, the copper containing biocide may be in the form of copper-complex such as N-nitroso-N-cyclohexyl-hydroxylamine-copper (copper-HDO) or copper pyrithione (bis(2-pyridylthio)copper 1,1′-dioxide, CAS number 14915-37-8), copper ethylenediamine complex, copper triethanolamine complex, copper diammonia diacetate complex and copper ethanolamine complex.

The copper containing biocide can be in the form of a copper (II) ion. For instance, forms of copper (II) include basic copper chloride, basic copper carbonate (Cu₂(OH)₂CO₃), copper (II) acetate, copper ammonium carbonate complex, copper (II) hydroxide, copper (II) oxide, copper oxychloride, copper oxychloride sulfate, copper ammonium complex, chelates of copper citrate, chelates of copper gluconate, and copper (II) sulphate pentahydrate,

In one embodiment the copper is independently selected from the group consisting of copper carbonate, basic copper carbonate, copper hydroxide, or combinations thereof.

In one embodiment the copper compound is basic copper carbonate.

In one embodiment, the copper containing biocide used in the invention is in the form of a copper compound having a particle size 0.01 microns to 25.0 microns. In one embodiment particle size of the micronized copper compound used in the composition disclosed herein can be between 0.01 to 10 microns, 0.05 to 10 microns, between 0.1 to 10.0 microns, between 0.01 to 1.0 micron, between 0.05 to 1.0 microns, between 0.1 to 1.0 microns, between 0.2 to 1.0 microns. If a more uniform penetration is desired, particle size of the micronized copper compound used in the composition disclosed herein can be between 0.05 to 1.0 microns.

In one embodiment, notwithstanding the type or amount of copper containing biocide(s) selected, the copper containing biocide may be present in micronized form, or in combination with a dispersing agent. For instance, the copper particles may have a particle size D50 of about 25 microns or less, such as about 10 microns or less, such as about 6 microns or less, such as about 5 microns or less, such as about 4 microns or less, such as about 3 microns or less, such as about 2 microns or less, such as about 1 micron or less.

Notwithstanding the form of the copper containing biocide, the copper containing biocide may be present in the composition form about 1% to about 75% by weight of the composition, such as about 2% to about 45%, such as about 3% to about 40%, such as about 4% to about 35%, such as about 5% to about 32.5%, such as about 6% to about 30%, such as about 7.5% to about 27.5% by weight of the composition, or any ranges or values there between.

The zinc containing biocides used in the composition of the present invention are known and include but are not limited to, for example zinc sulfate, basic zinc sulfate, zinc chloride, basic zinc chloride, zinc bromide, zinc iodide, zinc carbonate, basic zinc carbonate, zinc hydroxide, basic zinc phosphate, basic zinc phosphosulfate, basic zinc nitrate, zinc oxide, zinc naphthenate, zinc trichlorophenoxide, zinc formate, zinc acetate, zinc naphthenate or zinc pyrithione (bis(2-pyridylthio)zinc 1,1′-dioxide—CAS number 13463-41-7).

In one embodiment the zinc containing biocide may be incorporated into the composition in the form of inorganic zinc salts, such as acetate, carbonate, bicarbonate, chloride, hydroxide, borate, oxide or phosphate, or in the form of a an organozinc compound such as a simple organic salt, such as formate or acetate, or as a complex such as N-nitroso-N-cyclohexyl-hydroxylaminezinc (zinc-HDO), zinc naphthenate or zinc pyrithione (bis(2-pyridylthio)zinc 1,1′-dioxide—CAS number 13463-41-7).

In one embodiment the zinc containing biocide may comprise a zinc salt, such as a zinc salt of an organic acid, an inorganic acid, or a combination thereof.

In another embodiment the zinc containing biocide is independently selected from the group consisting of zinc oxide, zinc acetate, zinc hydroxide or a combination thereof.

In one embodiment, the zinc containing biocide used in the invention is in the form of a zinc compound having a particle size 0.01 microns to 25.0 microns. In one embodiment particle size of the micronized zinc compound used in the composition disclosed herein can be between 0.01 to 10 microns, 0.05 to 10 microns, between 0.1 to 10.0 microns, between 0.01 to 1.0 micron, between 0.05 to 1.0 microns, between 0.1 to 1.0 microns, between 0.2 to 1.0 microns. If a more uniform penetration is desired, particle size of the micronized copper compound used in the composition disclosed herein can be between 0.05 to 1.0 microns.

In one embodiment, notwithstanding in the type or amount of zinc containing biocide(s) selected, the zinc containing biocide may be present in micronized form, alone or in combination with a dispersing agent. For instance, in one embodiment the zinc particles may have a particle size D50 of about 25 microns or less, such as about 10 microns or less, such as about 6 microns or less, such as about 5 microns or less, such as about 4 microns or less, such as about 3 microns or less, such as about 2 microns or less, such as about 1 micron or less. It is known to use zinc borate to protect wood or cellulose-based products, including particle board, hardboard and oriented strand board, from fungal decay, as described in U.S. Pat. Nos. 4,879,083; 5,763,338; and 5,972,266. Solid zinc borate is added to wood composites during manufacture, because its inherent low solubility reduces leaching of the preservative in high moisture environments. Examples of such zinc borate compound include zinc metaborate, diboron trizinc hexaoxide ((Zn₂(B(OH)₃)₃), basic zinc borate and zinc borate tetrahydrate (2ZnO×3B₂O₃×3.5H₂O). Dev et al. (J Timb. Dev. Assoc., 1997) described a two-stage process for treating solid wood with zinc borate in which the wood is treated with solutions of borax and zinc chloride in two separate steps. However, the high cost of retreating and rehandling the wood makes the commercial use of such multi-stage processes unattractive, and, zinc borate is not particularly effective against mold fungi.

However, it should be understood that, and as will be discussed in greater detail below, the use of zinc borate as the zinc containing biocide does not provide the required ratio of zinc or boric acid equivalents based on weight to the preservative composition. Particularly, zinc borate alone fails to provide enough zinc to form the copper to zinc weight ratios of the present disclosure while maintaining the weight ratios of copper to boric acid equivalents based on weight. Thus, when zinc borate is used as the zinc containing biocide, a further zinc compound has to be used together with the zinc borate to ensure that the synergistic effect is achieved.

In one embodiment, notwithstanding the zinc containing biocide selected, the zinc containing biocide may be present in the composition such form about 0.01% to about 50% by weight of the composition, such as about 0.1% to about 45%, such as about 0.25% to about 40%, such as about 0.5% to about 35%, such as about 0.75% to about 32.5%, such as about 1% to about 30%, such as about 1.5% to about 27.5% by weight of the composition, based on the total weight of the composition, or any ranges or values therebetween.

The copper containing biocide and the zinc containing biocide may be included in the composition of the invention as a solubilized metal ion. Suitable methods for solubilizing metal ions such as copper and zinc are known in the art, for example from WO93/02557. Suitable complexing agents for the copper or zinc ion include, for example, polyphosphoric acids such as tripolyphosphoric acid; ammonia; water soluble amines and alkanolamines capable of complexing with copper or zinc cations: aminocarboxylic acids such as glycine, glutamic acid, ethylenediaminetetraacetic acid (EDTA), hydroxyethyldiamine triacetic acid, nitrilotriacetic acid and N-dihydroxy ethylglycine. Where the complexing agents are acidic in nature they may be employed either as free acids or as their alkali metal or ammonium salts. These complexing agents may be used either alone or in combination with each other.

In one embodiment, the copper containing biocide and the zinc containing biocide may be complexed with an amino compound selected from the group consisting of ammonia, a water soluble amine or alkanolamine and an aminocarboxylic acid. Amino compounds suitable for complexing a copper containing biocide and a zinc containing biocide are ammonia, monoethanolamine and primary, secondary or tertiary amines incorporating a C₈-C₁₄ alkyl chains, preferably C₁₂ alkyl chains, e.g. laurylamine or dimethyl laurylamine

In one embodiment the complexing agents may be independently selected from the group consisting of alkanolamines, such as monoethanolamine, diethanolamine, triethanolamine, monopropanolamine, dipropanolamine, and tripropanolamine or combinations thereof.

In another embodiment the complexing agents may be independently selected from the group consisting of ethanolamine, monoethanolamine or combinations thereof.

In another embodiment the complexing agents may be monoethanolamine.

In another embodiment the copper containing biocide may be present as copper ammonium complex.

In another embodiment the zinc containing biocide may be present as zinc ammonium complex.

The boron containing biocides used in the composition of the present invention are known and include but are not limited to, for example soluble and insoluble borates, boric acid, diboron tetrahydroxide, a borate, a boron oxide, a borane, erborates, metaborates, tetraborates, octaborates, borate esters. Suitable boron compounds, include, but are not limited to, boranes and borate esters that produce oxides of boron in aqueous media. Further examples of boron containing biocides are metallic borates (like sodium borate, calcium borate, magnesium borate, zinc borate, potassium borate, copper borate), such as disodium tetraborate decahydrate, disodium octaborate tetrahydrate, sodium metaborate, sodium perborate monohydrate, disodium octaborate, sodium tetraborate pentahydrate, sodium tetraborate, copper metaborate, zinc borate, barium metaborate. Further suitable boron containing biocides are bis(2-aminoethyl) borate.

In one embodiment the boron containing biocide is independently selected from the group consisting of boric oxide, boric acid, salts of boric acid, boric acid esters, sodium borate, calcium borate, magnesium borate, zinc borate, disodium octaborate tetrahydrate, copper borate, silicate borates or combinations thereof.

In one embodiment the boron containing biocide is independently selected from the group consisting of boric acid, boric acid esters, boric oxide, disodium octaborate tetra or combinations thereof.

In one embodiment the boron containing biocide is disodium octaborate tetrahydrate.

In one embodiment the boron containing biocide is boric acid.

In one embodiment the boron containing biocide may be independently selected from the group consisting of a boric acid ester selected from trihexyleneglycol biborate and compounds having the general formula (I)

B—(O—R)₃ (I)

or the general formula (II)

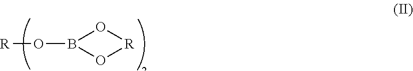

wherein R is independently selected from the group consisting of C₁-C₁₈ alkyl, aryl or combinations thereof.

In one embodiment the boric acid ester may be trihexyleneglycol biborate.

In one embodiment, the boron containing biocide may also be micronized, and have any one or more of the particle sizes discussed herein.

In one embodiment the boron containing biocide may be present in the composition form about 0.01% to about 75% by weight of the composition, such as about 0.1% to about 70%, such as about 0.25% to about 65%, such as about 0.5% to about 60%, such as about 0.75% to about 57.5%, such as about 1% to about 55%, such as about 1.5% to about 52.5% by weight of the composition, based on the total weight of the composition, or any ranges or values therebetween.

The preservative composition of the present invention further includes at least one organic biocide. In one embodiment the organic biocide is a fungicide.

The fungicides used in the composition of the present invention are known and include but are not limited to, for example to azoles (including but are not limited to benzimidazoles, imidazoles and triazoles), morpholine derivatives, quaternary ammonium compounds, isothiazolones, pyrazolecarboxamides, phenylpyrazoles, haloalkynyl compounds, strobilurins, phenylsulfamides.

In one embodiment the organic biocide can be independently selected from the group consisting of azoles, quaternary ammonium compounds, isothiazolones, pyrazolecarboxamides, phenylpyrazoles, haloalkynyl compounds or combinations thereof.

In one embodiment the organic biocide may comprise an azole.

In one embodiment, the azole fungicides can be independently selected from the group consisting of imidazole, benzimidazole, triazole, or combinations thereof.

In one embodiment the organic biocide may comprise a triazole.

In one embodiment the organic biocide may comprise a quaternary ammonium compound.

In one embodiment the organic biocide may comprise an isothiazolone.

In one embodiment the organic biocide may comprise a pyrazolecarboxamide.

In one embodiment the organic biocide may comprise a phenylpyrazole.

In one embodiment the organic biocide may comprise an haloalkynyl compound

The azole compound, i.e. a compound comprising an azole group, may be an imidazole or a 1,2,4-triazole and is preferably represented by the general formula (III)

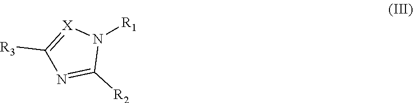

wherein
X is independently selected from CR₄ or N;
R₁ is independently selected from the group consisting of hydrogen or a linear, branched, cyclic, aromatic saturated or unsaturated, substituted or unsubstituted C₁ to C₄₀ group or combinations thereof,
wherein any of the carbon atoms other than those bound to the nitrogen atom shown in formula (A) may be replaced with an optionally substituted hetero atom;
R₂ is independently selected from the group consisting of hydrogen, C₁-C₈ alkyl, C₂-C₈ alkenyl, C₅-C₁₀ aryl, C₅-C₁₀ heteroaryl or C₁-C₄ alkyl carbamate; and
R₃ and R₄ are hydrogen; or
R₃ and R₄ together may provide a benzimidazole group.

In one embodiment the azole compound may be a imidazole.

An imidazole compound incorporates a five-membered di-unsaturated ring composed of three carbon atoms and two nitrogen atoms at non-adjacent positions.

In one embodiment the imidazole compound may be independently selected from the group consisting of 1-[2-(2,4-dichlorophenyl)-2-(2-propen-1-yloxy)ethyl]-1H-imidazole (imazalil), N-propyl-N-[2-(2,4,6-trichlorophenoxy)ethyl]-1H-imidazole-1-carboxamide (prochloraz), or combinations thereof.

In one embodiment the imidazole compound may be a benzimidazole.

In one embodiment the benzimidazole may be independently selected from the group consisting of 2-(4-thiazolyl)-1H-benzimidazole (thiabendazole), methyl N-1H-benzimidazol-2-ylcarbamate (carbendazim), 2-(2-furanyl)-1H-benzimidazole (fuberidazole) or combinations thereof.

In one embodiment the azole compound may be a 1,2,4-triazole compound.

A 1,2,4-triazole compound incorporates a five-membered di-unsaturated ring composed of three nitrogen atoms and two carbon atoms at non-adjacent positions.

In one embodiment the 1,2,4-triazole compounds can be independently selected from a compound of formula (IV):

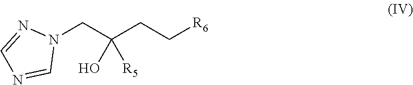

wherein
R₅ is independently selected from the group consisting of s a branched or straight C₁-C₅ alkyl group (e.g. t-butyl), and
R is independently selected from the group consisting of a phenyl group optionally substituted by one or more substituents, selected from halogen (e.g. chlorine, fluorine or bromine) atoms or C₁-C₃ alkyl (e.g. methyl), C₁-C₃ alkoxy (e.g. methoxy), phenyl or nitro groups.

In another embodiment the 1,2,4-triazole compound can be independently selected from a compound of formula (V):

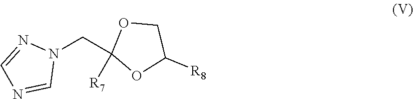

wherein
R₇ is independently selected from the group consisting of a phenyl group optionally substituted by one or more substituents, selected from halogen (e.g. chlorine, fluorine or bromine) atoms or C₁-C₃ alkyl (e.g. methyl), C₁-C₃ alkoxy (e.g. methoxy), phenyl or nitro groups, and
R₈ is independently selected from the group consisting of a hydrogen atom or a branched or straight chain C₁-C₈ alkyl group (e.g. methyl, ethyl, propyl, etc).

The 1,2,4-triazole compounds used in the composition of the present invention are known and include but are not limited to, for example 1-[[2-(2,4-dichlorophenyl)-1,3-dioxolan-2-yl]methyl]-1H-1,2,4-triazole (azaconazole), 1-[[4-bromo-2-(2,4-dichlorophenyl)tetrahydro-2-furanyl]methyl]-1H-1,2,4-triazole (bromuconazole), α-(4-chlorophenyl)-α-(1-cyclopropyl ethyl)-1H-1,2,4-triazole-1-ethanol (cyproconazole), (2RS,3RS)-1-(2,4-dichlorophenyl)-4,4-dimethyl-2-(1H-1,2,4-triazol-1-yl)pentan-3-ol (diclobutrazol), 1-[[2-[2-chloro-4-(4-chloro phenoxy)phenyl]-4-methyl-1,3-dioxolan-2-yl]methyl]-1H-1,2,4-triazole (difenoconazole), (E)-(RS)-1-(2,4-dichlorophenyl)-4,4-dimethyl-2-(1H-1,2,4-triazol-1-yl)pent-1-en-3-ol (diniconazole), (E)-(R)-1-(2,4-dichlorophenyl)-4,4-dimethyl-2-(1H-1,2,4-triazol-1-yl) pent-1-en-3-ol (diniconazole-M), (2RS,3SR)-1-[3-(2-chlorophenyl)-2,3-epoxy-2-(4-fluorophenyl) propyl]-1H-1,2,4-triazole (epoxiconazole), 1-[[2-(2,4-dichlorophenyl)-4-ethyl-1,3-dioxolan-2-yl]methyl]-1H-1,2,4-triazole (etaconazole), α-[2-(4-chlorophenyl)ethyl]-α-phenyl-1H-1,2,4-triazole-1-propanenitrile (fenbuconazole), 3-(2,4-dichlorophenyl)-6-fluoro-2-(1H-1,2,4-triazol-1-yl)quinazolin-4(3H)-one (fluquinconazole), 1-[[bis(4-fluorophenyl)methylsilyl]methyl]-1H-1,2,4-triazole (flusilazole), α-(2-fluorophenyl)-α-(4-fluorophenyl)-1H-1,2,4-triazole-1-ethanol (flutriafol), 1-[[2-(2,4-dichlorophenyl)tetrahydro-5-(2,2,2-trifluoroethoxy)-2-furanyl]methyl]-1H-1,2,4-triazole (furconazole), (2RS,5RS)-5-(2,4-dichlorophenyl)tetrahydro-5-(1H-1,2,4-triazol-1-ylmethyl)-2-furyl 2,2,2-trifluoroethyl ether (furconazole-cis), α-butyl-α-(2,4-dichlorophenyl)-1H-1,2,4-triazole-1-ethanol (hexaconazole), (4-chlorophenyl)methyl N-(2,4-dichlorophenyl)-1H-1,2,4-triazole-1-ethanimidothioate (imibenconazole), 2-[(4-chlorophenyl) methyl]-5-(1-methylethyl)-1-(1H-1,2,4-triazol-1-ylmethyl)cyclopentanol (ipconazole), 5-[(4-chlorophenyl)methyl]-2,2-dimethyl-1-(1H-1,2,4-triazol-1-ylmethyl)cyclopentanol (metconazole), α-butyl-α-(4-chlorophenyl)-1H-1,2,4-triazole-1-propanenitrile (myclobutanil), 1-[2-(2,4-dichlorophenyl)pentyl]-1H-1,2,4-triazole (penconazole), 1-[[2-(2,4-dichlorophenyl)-4-propyl-1,3-dioxolan-2-yl]methyl]-1H-1,2,4-triazole (propiconazole), 2-[2-(1-chlorocyclo propyl)-3-(2-chlorophenyl)-2-hydroxypropyl]-2,4-dihydro-3H-1,2,4-triazole-3-thione 20) (prothioconazole), 3-(2,4-dichlorophenyl)-2-(1H-1,2,4-triazol-1-yl)-4(3H)-quinazolinone (quinconazole), α-(4-fluorophenyl)-α-[(trimethylsilyl)methyl]-1H-1,2,4-triazole-1-ethanol (simeconazole), α-[2-(4-chlorophenyl)ethyl]-α-(1,1-dimethylethyl)-1H-1,2,4-triazole-1-ethanol (tebuconazole), 1-[2-(2,4-dichlorophenyl)-3-(1,1,2,2-tetrafluoroethoxy)propyl]-1H-1,2,4-triazole (tetraconazole), 1-(4-chlorophenoxy)-3,3-dimethyl-1-(1H-1,2,4-triazol-1-yl)-2-butanone (triadimefon), β-(4-chlorophenoxy)-α-(1,1-dimethylethyl)-1H-1,2,4-triazole-1-ethanol (triadimenol), (5E)-5-[(4-chlorophenyl)methylene]-2,2-dimethyl-1-(1H-1,2,4-triazol-1-ylmethyl)cyclopentanol (triticonazole), (BE)-β-[(4-chlorophenyl)methylene]-α-(1,1-dimethylethyl)-1H-1,2,4-triazole-1-ethanol (uniconazole), (αS,βE)-β-[(4-chlorophenyl) methylene]-α-(1,1-dimethylethyl)-1H-1,2,4-triazole-1-ethanol (uniconazole-P).

In one embodiment the 1,2,4-triazole fungicide can be independently selected from the group consisting of cyproconazole, fenbuconazole, propiconazole, tebuconazole, triadimefon, triticonazole or combinations thereof.

In one embodiment the azole fungicide can be independently selected from the group consisting of tebuconazole or propiconazole or combinations thereof.

In one embodiment the azole fungicide can be selected from tebuconazole.

In one embodiment the azole fungicide can be selected from propiconazole.

In one embodiment the preservative composition of the present disclosure may contain one or more azole compounds, such as mixtures of an imidazole and a 1,2,4-triazole, or mixtures of two or more 1,2,4-triazoles. Using a mixture of azoles may allow a broader range of activity against fungi in some aspects.

In another embodiment the preservative composition of the present disclosure utilizes one or more 1,2,4-triazole(s) alone or in combination with an imidazole.

In one embodiment if a mixture of propiconazole and tebuconazole is utilized, propiconazole and tebuconazole are used in mixture in a weight ratio of propiconazole to tebuconazole of about 1:10 to about 10:1, such as about 1:5 to about 5:1, such as about 1:1 to 5:1, such as about 3:1 by weight, or any ranges or values therebetween.

Regardless of the azole or azoles selected, the azole may be present in the preservative composition in an amount of about 0.01% to about 20% by weight, such as about 0.1% to about 18%, such as about 0.25% to about 16%, such as about 0.5% to about 15%, such as about 0.75% to about 14%, such as about 0.9% to about 12.5% by weight of the composition, or any ranges or values therebetween.

In one embodiment notwithstanding the type or amount of azole(s) selected, the azole may be present in micronized form, alone or in combination with a dispersing agent. For instance, in an aspect, the azole particles have a particle size D50 of about 25 microns or less, such as about 10 microns or less, such as about 6 microns or less, such as about 5 microns or less, such as about 4 microns or less, such as about 3 microns or less, such as about 2 microns or less, such as about 1 micron or less.

The pyrazolecarboxamides used in the composition of the present invention are known and include but are not limited to, for example to N-(3′,4′-dichloro-5-fluoro[1,1′-biphenyl]-2-yl)-3-(difluoromethyl)-1-methyl-1H-pyrazole-4-carboxamide (benzovindiflupyr), N-(3′,4′-dichloro-5-fluoro[1, 1′-biphenyl]-2-yl)-3-(difluoromethyl)-1-methyl-1H-pyrazole-4-carboxamide (bixafen), N-[2-[2-chloro-4-(trifluoromethyl)phenoxy]phenyl]-3-(difluoromethyl)-1-methyl-1H-pyrazole-4-carboxamide (flubeneteram), 3-(difluoromethyl)-N-(7-fluoro-2,3-dihydro-1,1,3-trimethyl-1H-inden-4-yl)-1-methyl-1H-pyrazole-4-carboxamide (fluindapyr), 5-chloro-N-(1,3-dihydro-1,1,3-trimethyl-4-isobenzofuranyl)-1,3-dimethyl-1H-pyrazole-4-carboxamide (furametpyr), 3-(difluoromethyl)-1-methyl-N-(3′,4′,5′-trifluoro[1,1′-biphenyl]-2-yl)-1H-pyrazole-4-carboxamide (fluxapyroxad), N-[[5-chloro-2-(1-methylethyl)phenyl]methyl]-N-cyclopropyl-3-(difluoromethyl)-5-fluoro-1-methyl-1H-pyrazole-4-carboxamide (isoflucypram), 3-(difluoromethyl)-1-methyl-N-[1,2,3,4-tetrahydro-9-(1-methylethyl)-1,4-methanonaphthalen-5-yl]-1H-pyrazole-4-carboxamide (isopyrazam), N-[2-(1,3-dimethylbutyl)phenyl]-5-fluoro-1,3-dimethyl-1H-pyrazole-4-carboxamid (penflufen), N-[2-(1,3-dimethylbutyl)-3-thienyl]-1-methyl-3-(trifluoromethyl)-1H-pyrazole-4-carboxamide (penthiopyrad), 3-(difluoromethyl)-N-methoxy-1-methyl-N-[1-methyl-2-(2,4,6-trichlorophenyl)ethyl]-1H-pyrazole-4-carboxamide (pydiflumentofen), N-[2-[1,1′-bicyclopropyl]-2-ylphenyl]-3-(difluoromethyl)-1-methyl-1H-pyrazole-4-carboxamide (sedaxane).

In one embodiment the pyrazolecarboxamide can be penflufen.

The isothiazolones used in the composition of the present invention are known and include but are not limited to, for example to 2-methyl-4-isothiazolin-3-one (MIT), 5-chloro-2-methyl-4-isothiazolin-3-one (CMIT), 4,5-dichloro-2n-octylisothiazolin-3-one (DCOIT), 5-chloro-2n-octyl-4-isothiazolin-3-one (COIT), 4,5-dichloro-2-cyclohexyl-4-isothiazolin-3-one, 2-octyl-2H-isothiazolin-3-one (OIT), 1,2-benzothiazolin-3-one (BIT), N-methyl-1,2-benzisothiazolin-3-one (MBIT), 2-butyl-1,2-benzisothiazolin-3(2H)-one (BBIT) and 2-methyl-4,5-trimethylene-4-isothiazolin-3-one.

In one embodiment the isothiazolone can be independently selected from the group consisting of 2-methyl-4-isothiazolin-3-one (MIT), 5-chloro-2-methyl-4-isothiazolin-3-one (CMIT), 4,5-dichloro-2n-octylisothiazolin-3-one (DCOIT), 5-chloro-2n-octyl-4-isothiazolin-3-one (COIT), 4,5-dichloro-2-cyclohexyl-4-isothiazolin-3-one, 2-octyl-2H-isothiazolin-3-one (OIT), 1,2-benzothiazolin-3-one (BIT), N-methyl-1,2-benzisothiazolin-3-one (MBIT), or 2-butyl-1,2-benzisothiazolin-3(2H)-one (BBIT) or combinations thereof.

In one embodiment the isothiazolone can be independently selected from the group consisting of 2-methyl-4-isothiazolin-3-one (MIT), 5-chloro-2-methyl-4-isothiazolin-3-one (CMIT), 4,5-dichloro-2n-octylisothiazolin-3-one (DCOIT), 2-octyl-2H-isothiazolin-3-one (OIT) or combinations thereof.

In one embodiment the isothiazolone is ing 4,5-dichloro-2n-octylisothiazolin-3-one (DCOIT).

The quaternary ammonium compounds used in the composition of the present invention are known and include but are not limited to, for example tetraalkyl ammonium salts, trialkyl aryl ammonium salts, trialkyl ammonium oxide salts, or combinations thereof

The quaternary ammonium compounds used in the composition of the present invention are known and include but are not limited to, for example to quaternary ammonium compounds having a general formula (VI)

NR₁R₂R₃R₄—X (VI)
wherein
R₁, R₂, R₃, R₄ are independently selected from the group consisting of linear, branched, saturated or unsaturated C₁-C₁₈ alkyl, C₁-C₁₈ alkenyl, C₁-C₁₈ alkynyl, C₁-C₄ hydroxyalkyl, C₂-C₅ hydroxyalkenyl, C₂-C₅ hydroxyalkynyl C₅-C₁₂ aryl, C₅-C₁₂ aralkyl, C₃-C₅ hydroxyaryl,
X is independently selected from halogen, carbonate, bicarbonate, hydroxide, boric acid, or combinations thereof.

In one embodiment the quaternary ammonium compound is independently selected form the group consisting of compounds of formula (VI) wherein
R₁, R₂, R₃, R₄ are independently selected from the group consisting of methyl, ethyl, octyl, decyl, didecyl,
X is independently selected from halogen, carbonate, bicarbonate, hydroxide, boric acid,
or combinations thereof.

The quaternary ammonium compounds used in the composition of the present invention are known and include but are not limited to, for example to trimethyl alky quaternary ammonium compounds such as cocotrimethyl ammonium chloride; dialkyldimethyl quaternary ammonium compounds such as didecyl dimethyl ammonium chloride, didecyl dimethyl ammonium carbonate, didecyl dimethyl ammonium bicarbonate, dioctyl dimethyl ammonium chloride and octyl decyl dimethyl ammonium chloride, or mixtures thereof; alkyl dimethyl or diethyl benzyl ammonium salts such as benzalkonium chloride and benzalkonium hydroxide; polyethoxylated quaternary ammonium compounds such as N,N-didecyl-N-methyl-poly(oxyethyl) ammonium propionate (Bardap 26) or N.N-didecyl-N-methyl-poly(oxyethyl) ammonium lactate; monoalkylmethyl bisalkoxylated quaternary ammonium compounds such as cocoalkylmethyl bis(hydroxyethyl) ammonium chloride, ethoxylated; dialkyl bisalkoxylated quaternary ammonium compounds such as didecyl bis(hydroxyethyl) ammonium hydroxide, ethoxylated; quaternary ammonium compounds complexed with an additional compound, such as a boron containing compound, for example, boric acid, like didecyl bis(hydroxyethyl) ammonium borate, also referred to as a polymeric betaine.

In one embodiment the quaternary ammonium compound can be independently selected from the group consisting of benzalkonium chloride, didecyl bis(hydroxyethyl) ammonium borate, didecyl dimethyl ammonium chloride, didecyl dimethyl ammonium carbonate, didecyl dimethyl ammonium bicarbonate or combinations thereof.

In one embodiment the quaternary ammonium compound can be independently selected from the group consisting of benzalkonium chloride, didecyl dimethyl ammonium chloride, didecyl dimethyl ammonium carbonate, didecyl dimethyl ammonium bicarbonate or combinations thereof.

In one embodiment the quaternary ammonium compound can be independently selected from the group consisting of didecyl dimethyl ammonium chloride, didecyl dimethyl ammonium carbonate, didecyl dimethyl ammonium bicarbonate or combinations thereof.

In another embodiment the quaternary ammonium compound can be independently selected from the group consisting of didecyl dimethyl ammonium carbonate, didecyl dimethyl ammonium bicarbonate or combinations thereof.

The haloalkylnyl compounds used in the composition of the present invention are known and generally referred to as iodopropynyl carbamates or carabamic acid esters of the following formula (VII):

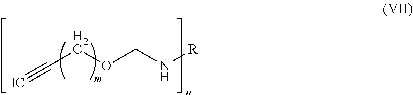

wherein
R is independently selected from the group consisting of hydrogen, substituted and unsubstituted C₁-C₂₀ alkyl groups, substituted and unsubstituted C₆-C₂₀ aryl, C₆-C₂₀ alkylaryl, and C₆-C₂₀ aralkyl, C₃-C₁₀ cycloalkyl, or C₃-C₁₀ cycloalkenyl, and
m and n are independently integers from 1 to 3,
or combinations thereof.

In one embodiment the iodopropynyl carbamate can be independently selected from compound of formula (VIII)

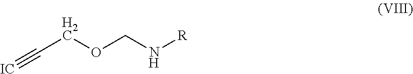

wherein
R is independently selected from then group consisting of methyl, ethyl, propyl, n-butyl, t-butyl, pentyl, hexyl, heptyl, octyl, nonyl, decyl, dodecyl, octadecyl, cyclohexyl, phenyl, benzyl, tolyl, cumyl, chlorobutyl, chlorophenyl, ethoxyphenyl, or combinations thereof.

In one embodiment the iodopropynyl compounds can be independently selected from the group consisting of 3-iodo-2-propynyl propyl carbamate, 3-iodo-2-propynyl butyl carbamate, 3-iodo-2-propynyl hexyl carbamate, 3-iodo-2-propynyl cyclohexyl carbamate, 3-iodo-2-propynyl phenyl carbamate, or combinations thereof.

In another embodiment, the iodopropynyl compound can be 3-iodo-2-propynyl butyl carbamate (IPBC).

Furthermore, the preservative composition may also include a dispersing agent and/or solvent. The dispersing agent and/or solvent may be an alkanolamine, such as monoethanolamine, diethanolamine, triethanolamine, monopropanolamine, dipropanolamine, and tripropanolamine. In one embodiment the dispersing agent and/or solvent is an ethanolamine, such as monoethanolamine. However, it should be understood that other dispersing agents and/or solvents as known in the art may be used. As a particular example, the above recited dispersing agents and/or solvents may be a solvent for boric acid in certain example embodiments.

Additionally, or alternatively, the dispersing agent may be complexed with some or all of one or more components of the preservative composition. For instance, the dispersing agent may be complexed with at least a portion of the organic biocide, the copper containing biocide, the zinc containing biocide or any combination thereof. However, it should be understood that, in one aspect, at least a portion of the dispersing agent may be “free” in solution in the sense that at least a portion is not complexed with another component.

Additionally, or alternatively, the dispersing agent may be complexed with at least a portion of the azole, the copper containing biocide, the zinc containing biocide or any combination thereof. However, it should be understood that, in one aspect, at least a portion of the dispersing agent may be “free” in solution in the sense that at least a portion is not complexed with another component.

The above combination of copper containing biocide, zinc containing biocide, boron containing biocide and one or more organic biocide, may be used alone as a preservative composition.

However, in one aspect, the preservative composition may comprise one or more further second organic co-biocide selected from fungicides (fungicidal wood decay preservatives) or insecticides, wherein the second organic biocide can be other than the above.

For instance, organic fungicidal wood decay preservatives suitable for use in the preservative composition of the present disclosure include fungicidal amides such as prochloraz, dichlofluanid and tolylfluanid; fungicidal aromatic compounds such as chlorthalonil, cresol, dicloran, pentachlorophenol, sodium pentachlorophenol, 2-(thiocyanatomethylthio)-1,3-benzothiazole (TCMBC), dichlorophen, fludioxonil and 8-hydroxyquinoline; fungicidal heterocyclic compounds such as dazomet, fenpropimorph, bethoxazin and dehydroacetic acid; strobilurins such as azoxystrobin; pyraclostrobin; fluazinam; quaternary ammonium compounds; isothiazolones; pyrithiones; and mixtures thereof.

In one embodiment the preservative composition may include one or more further fungicide wood decay preservatives independently selected from the group consisting of azoles, quaternary ammonium compounds, isothiazolones, pyrithiones, or combinations thereof.

In one embodiment the further fungicide wood decay preservatives is an azole as defined above.

In one embodiment the further fungicide wood decay preservatives is a quaternary ammonium compound as defined above.

In one embodiment the further fungicide wood decay preservatives is an isothiazolone compound as defined above.

In one embodiment the further fungicide wood decay preservatives is a pyrithione independently selected from the group consisting of sodium pyrithione, zinc pyrithione, copper pyrithione, 1-hydroxy-2-pyridinone and pyrithione disulfide or mixtures thereof.

In one embodiment the preservative composition may include one or more further organic biocide selected an insecticide.

The insecticides that can be used in the composition of the present invention are known and include but are not limited to, for example pyrethroids, neonicotinoids, organophosphates, borates.

In one embodiment the insecticide that can be used in the composition of the present invention is independently selected from pyrethroids, neonicotinoids, organophosphates, borates or combinations thereof.

In one embodiment the insecticide that can be used in the composition of the present invention is a pyrethroid.

The pyrethroid compounds that may be used in the wood preservative composition of the present invention are known and include but are not limited to, for example to acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen.

In one embodiment, the pyrethroid compound may be independently selected from the group consisting of bifenthrin, cypermethrin, permethrin, or a mixture thereof.

In one embodiment, the pyrethroid compound may be independently selected from the group consisting of bifenthrin, permethrin, or a mixture thereof.

In one embodiment, the insecticide that can be used in the composition of the present invention is a neonicotinoid.

The neonicotinoids compounds that may be used in the wood preservative composition of the present invention are known and include but are not limited to, for example to (1E)-N-[(6-chloro-3-pyridinyl)methyl]-N′-cyano-N-methylethanimidamide (acetamiprid), (E)-1-[(2-chlorothiazol-5-yl)methyl]-3-methyl-2-nitroguanidine (clothianidin), (2E)-1-[(6-chloro-3-pyridinyl)methyl]-N-nitro-2-imidazolidinimine (imidacloprid), (1E)-N-[(6-chloro-3-pyridinyl)methyl]-N-ethyl-N′-methyl-2-nitro-1,1-ethenediamine (nitenpyram), tetrahydro-2-(nitromethylene)-2H-1,3-thiazine (nithiazine), (Z)-[3-[(6-chloro-3-pyridinyl)methyl]-2-thiazolidinylidene]cyanamide (thiacloprid) and 3-[(2-chloro-5-thiazolyl)methyl]tetrahydro-5-methyl-N-nitro-4H-1,3,5-oxadiazin-4-imine (thiamethoxam).

In one embodiment, the neonicotinoids compound may be imidacloprid.

In one embodiment, the insecticide that can be used in the composition of the present invention may comprise an organophosphate.

In one embodiment, the insecticide that can be used in the composition of the present invention may comprise a borate.

In another embodiment, the borate compound can be disodium octaborate tetrahydrate (DOT).

Nonetheless, when present, the further organic biocide selected from fungicide (fungicide wood decay preservative) or insecticide can be present in amounts of about 10% or less, such as about 9% or less, such as about 8% or less, such as about 7% or less, such as about 6% or less, such as about 5% or less, such as about 4% or less, such as about 3% or less, such as about 2% or less, such as about 1% or less, such as about 0.5% or less by weight of the composition.

However, as discussed above, it should be understood that the preservative composition may also be generally free of any one, or combination of further organic fungicidal preservatives due to the unexpected synergism of the preservative composition of the present disclosure.

Furthermore, the preservative composition may include a solvent, a surfactant, a diluent, an emulsifier, or a combination thereof.

For instance, the above referenced amounts and ratios correspond to a preservative composition that can be considered to be a concentrate. The preservative composition, regardless of whether the preservative composition is present as a concentrate may comprise a solvent, a surfactant, or a combination thereof, present in the preservative composition in an amount sufficient to stabilize and maintain the above discussed “active” components in their dispersed or solubilized form.

Particularly, the preservative composition may be considered to be a concentrate present in the form of a liquid composition. However, it should be understood that, in one aspect, no solvent is present, and the preservative composition may be a solid implant or paste. However, in one aspect, the preservative composition is in the form of an emulsion made up of solubilized liquid droplets. Preferably, the emulsions are in the form of a micro-emulsion. The person skilled in the art of making emulsions knows how to make an emulsion according to the invention by the use of suitable solvents and emulsifying agents.

The preservative composition can be an aqueous solution, but one or more organic solvents or a mixture of water and an organic solvent could also be used. Suitable organic solvents include both aromatic and aliphatic hydrocarbon solvents such as white spirit, petroleum distillate, kerosene, diesel oils and naphthas. Also, glycol ethers, benzyl alcohol, 2-phenoxy ethanol, methyl carbitol, propylene carbonate, benzyl benzoate, ethyl lactate and 2-ethyl hexyl lactate may be used alone, or in combination with water.

When present in the preservative composition, the solvent may be present in an amount from about 0.1% to about 85% by weight, such as about 2% to about 80%, such as about 3% to about 75%, such as about 4% to about 70%, such as about 5% to about 65%, such as about 6% to about 60%, such as about 7% to about 55%, such as about 8% to about 50%, such as about 9% to about 45%, such as about 10% to about 40% by weight, or any ranges or values therebetween. Of course, as noted above, in one aspect, the preservative composition in the form of a concentrate may be generally free of solvent, and thus may be in the form of a solid or paste.

In one embodiment, the preservative composition comprises from about 1% to about 75% by weight copper containing biocide, from about 0.1% to about 50% by weight zinc containing biocide, from about 0.1% to about 75% by weight boric acid, about 0.1% to about 20% by weight organic fungicide based on the total weight of the wood preservative composition, and the balance solvent, surfactant, emulsifier, optional components (including a further organic fungicidal preservative) or combinations thereof.

For instance, in another embodiment, the preservative composition comprises from about 1% to about 50% by weight copper containing biocide, from about 0.1% to about 75% by weight zinc containing biocide, from about 0.1% to about 75% by weight boric acid, about 0.1% to about 20% by weight azole based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 1% to about 75% by weight copper containing biocide, from about 0.1% to about 50% by weight zinc containing biocide, from about 0.1% to about 75% by weight boric acid, about 0.1% to about 20% by weight quaternary ammonium compound based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 1% to about 75% by weight copper containing biocide, from about 0.1% to about 50% by weight zinc containing biocide, from about 0.1% to about 75% by weight boric acid, about 0.1% to about 20% by weight isothiazolone based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 1% to about 75% by weight copper containing biocide, from about 0.1% to about 50% by weight zinc containing biocide, from about 0.1% to about 75% by weight boric acid, about 0.1% to about 20% by weight pyrazolecarboxamide based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 1% to about 75% by weight copper containing biocide, from about 0.1% to about 50% by weight zinc containing biocide, from about 0.1% to about 75% by weight boric acid, about 0.1% to about 20% by weight iodopropynyl compound based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 5% to about 45% by weight copper containing biocide, from about 0.75% to about 32.5% by weight zinc containing biocide, from about 0.75% to about 32.5% by weight boric acid, from about 0.5% to about 15% by weight organic biocide based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 5% to about 45% by weight copper containing biocide, from about 0.75% to about 32.5% by weight zinc containing biocide, from about 0.75% to about 32.5% by weight boric acid, from about 0.5% to about 15% by weight azole based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 5% to about 45% by weight copper containing biocide, from about 0.75% to about 32.5% by weight zinc containing biocide, from about 0.75% to about 32.5% by weight boric acid, from about 0.5% to about 15% by weight quaternary ammonium compound based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 5% to about 45% by weight copper containing biocide, from about 0.75% to about 32.5% by weight zinc containing biocide, from about 0.75% to about 32.5% by weight boric acid, from about 0.5% to about 15% by weight isothiazolone based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 5% to about 45% by weight copper containing biocide, from about 0.75% to about 32.5% by weight zinc containing biocide, from about 0.75% to about 32.5% by weight boric acid, from about 0.5% to about 15% by weight pyrazolecarboxamide based on the total weight of the wood preservative composition, and the balance solvent, surfactant, emulsifier, optional components (including a further organic fungicidal or insecticidal preservative or combinations thereof) or combinations thereof.

In another embodiment, the preservative composition comprises from about 5% to about 45% by weight copper containing biocide, from about 0.75% to about 32.5% by weight zinc containing biocide, from about 0.75% to about 32.5% by weight boric acid, from about 0.5% to about 15% by weight iodopropynyl compound based on the total weight of the wood preservative composition, and the balance solvent, surfactant, emulsifier, optional components (including a further organic fungicidal or insecticidal preservative or combinations thereof) or combinations thereof.

Additionally or alternatively, in another embodiment, the preservative composition comprises from about 7.5% to about 27.5% by weight copper containing biocide, from about 1.5% to about 27.5% by weight zinc containing biocide, from about 1.5% to about 52.5% by weight boric acid, about 0.9% to about 12.5% by weight organic biocide based on the total weight of the wood preservative composition, and the balance solvent, surfactant, emulsifier, optional components (including a further organic fungicidal preservative) or combinations thereof.

Additionally or alternatively, in another embodiment, the preservative composition comprises from about 7.5% to about 27.5% by weight copper containing biocide, from about 1.5% to about 27.5% by weight zinc containing biocide, from about 1.5% to about 52.5% by weight boric acid, about 0.9% to about 12.5% by weight azole based on the total weight of the wood preservative composition, and the balance solvent, surfactant, emulsifier, optional components (including a further organic fungicidal preservative) or combinations thereof.

Additionally or alternatively, in another embodiment, the preservative composition comprises from about 7.5% to about 27.5% by weight copper containing biocide, from about 1.5% to about 27.5% by weight zinc containing biocide, from about 1.5% to about 52.5% by weight boric acid, about 0.9% to about 12.5% by weight quaternary ammonium compound based on the total weight of the wood preservative composition, and the balance solvent, surfactant, emulsifier, optional components (including a further organic fungicidal preservative) or combinations thereof.

Additionally or alternatively, in another embodiment, the preservative composition comprises from about 7.5% to about 27.5% by weight copper containing biocide, from about 1.5% to about 27.5% by weight zinc containing biocide, from about 1.5% to about 52.5% by weight boric acid, about 0.9% to about 12.5% by weight isothiazolone based on the total weight of the wood preservative composition, and the balance solvent, surfactant, emulsifier, optional components (including a further organic fungicidal preservative) or combinations thereof.

Additionally or alternatively, in another embodiment, the preservative composition comprises from about 7.5% to about 27.5% by weight copper containing biocide, from about 1.5% to about 27.5% by weight zinc containing biocide, from about 1.5% to about 52.5% by weight boric acid, about 0.9% to about 12.5% by weight pyrazolcarboxamide based on the total weight of the wood preservative composition, and the balance solvent, surfactant, emulsifier, optional components (including a further organic fungicidal preservative) or combinations thereof.

Additionally or alternatively, in another embodiment, the preservative composition comprises from about 7.5% to about 27.5% by weight copper containing biocide, from about 1.5% to about 27.5% by weight zinc containing biocide, from about 1.5% to about 52.5% by weight boric acid, about 0.9% to about 12.5% by weight iodopropynyl compound based on the total weight of the wood preservative composition, and the balance solvent, surfactant, emulsifier, optional components (including a further organic fungicidal preservative) or combinations thereof.

The preservative composition may be diluted prior to use with one or more diluents. The diluent may be a further amount of the one or more solvents discussed above, or may be an alternative diluent as known in the art. Regardless, the diluent may be added to the preservative composition at a ratio of diluent to preservative composition of about 300:1 to about 1:1, such as about 100:1 to about 1:1, such as about 75:1 to about 2:1, such as about 50:1 to about 3:1, such as about 40:1 to about 4:1, such as about 20:1 to about 5:1 based on weight, or any ranges or values therebetween. Thus, the preservative composition may be present in the ready to use formulation in an amount of about 20 wt % or less, such as about 15 wt % or less, such as about 10 wt % or less, such as about 7.5 wt % or less, such as about 5 wt % or less, such as about 2.5 wt % or less, such as about 2 wt % or less, such as about 1.5 wt % or less, such as about 1 wt % or less, such as about 0.1 wt % by weight of the ready to use formulation, or any ranges or values therebetween.

Stated in an alternative fashion, the diluent may be present in an amount such that the copper containing biocide are present in a ready to use formulation (e.g. diluted preservative formulation) in an amount of about 1% or less by weight, such as about 0.5% or less, such as about 0.1% or less, such as about 750 ppm or less, such as about 500 ppm or less, such as about 400 ppm or less, or any ranges or values therebetween. Similarly, the zinc containing biocide may be present in the ready to use formulation in an amount of about 1% by weight or less, such as about 0.5% or less, such as about 0.1% or less, such as about 750 ppm or less, such as about 500 ppm or less, such as about 400 ppm or less, such as about 200 ppm or less, such as about 100 ppm or less, or any values or ranges there between. The boron containing biocide may be present in the ready to use formulation in an amount of about 1% by weight or less, such as about 0.5% or less, such as about 0.1% or less, such as about 750 ppm or less, such as about 500 ppm or less, such as about 400 ppm or less, such as about 200 ppm or less, such as about 100 ppm or less, or any values or ranges there between. The one or more organic biocide may be present in the ready to use formulation in an amount of about 1% by weight or less, such as about 0.5% or less, such as about 0.1% or less, such as about 750 ppm or less, such as about 500 ppm or less, such as about 400 ppm or less, such as about 200 ppm or less, such as about 100 ppm or less, such as about 50 ppm or less, such as about 5 ppm or less, or any values or ranges therebetween.

The preservative composition, or the ready to use formulation can have a pH of about 3 to about 10, such as about 3.5 to about 9.5, such as about 4 to about 9, such as about 4.5 to about 8,5, such as about 5 to about 8, or any ranges or values there between. However, the above pH values refer to a pH of a preservative composition. Furthermore, the ready to use formulation can have a pH of about 4 to about 11, such as about 4.5 to about 10.5, such as about 5 to about 10, such as about 5.5 to about 9.5, such as about 6 to about 9, or any ranges or values there between. As known in the art, pH builders, pH buffers, and other pH adjusting agents may be used to obtain and stabilize the above pH values.

The preservative composition is used to treat a wood or wood cellulose-based substrate. wood or cellulose-based products which can be treated with a preservative composition of the present disclosure include, but are not limited to, lignocellulose substrates, wood plastic composites, cardboard and cardboard faced building products such as plasterboard, and cellulosic material, such as cotton. Also, leather, textile materials and even synthetic fibers, hessian, rope, and cordage as well as composite wood materials. For convenience, the present disclosure is described with reference to the treatment of wood but it will be appreciated that other cellulosic materials may be treated analogously. However, in one aspect, though not exclusively, the preservative composition is applied to sawn timber, logs or laminated veneer lumber, OSB, plywood, MDF or any other cellulose-based product. In one aspect, the substrate is wood or a wood composite material which is intended to become wet during its life, for example, wood for window frames, timber used above ground in exposed environments, such as decking and timber used in ground contact or fresh water environments.

In one embodiment, a treated wood or cellulose-based substrate may be treated with an amount of the preservative composition (or ready to use formulation) such that the treated wood or cellulose-based substrate includes from about 150 g/m³ (grams per cubic metre) to about 7.5 kg/m3 copper, such as about 200 g/m3 to about 6 kg/m3 copper containing biocide, about 40) g/m3 to about 2 kg/m3 zinc containing biocide, such as about 200 g/m3 to about 1.5 kg/m3 zinc containing biocide, about 20 g/m3 to about 3.5 kg/m3 boron containing biocide, such as about 40 g/m3 to about 3 kg/m3 boron containing biocide, about 10 g/m3 to about 300 g/m3 organic biocide, such as about 20 g/m3 to about 260 g/m3 organic biocide, wherein the organic biocide is a fungicide and can be independently selected from the group consisting of azoles, quaternary ammonium compounds, isothiazolones, pyrazolecarboxamides, phenylpyrazoles, haloalkynyl compounds or a combination thereof. For instance, as shown in the examples, the present disclosure has found that the preservative composition is able to penetrate even to the core of the wood or cellulose-based product, and evenly distribute the preservative.

In another embodiment, a treated wood or cellulose-based substrate may be treated with an amount of the preservative composition (or ready to use formulation) such that the treated wood or cellulose-based substrate includes from about 150 g/m³ (grams per cubic metre) to about 7.5 kg/m3 copper, such as about 200 g/m3 to about 6 kg/m3 copper containing biocide, about 40) g/m3 to about 2 kg/m3 zinc containing biocide, such as about 200 g/m3 to about 1.5 kg/m3 zinc containing biocide, about 20 g/m3 to about 3.5 kg/m3 boron containing biocide, such as about 40 g/m3 to about 3 kg/m3 boron containing biocide, about 10 g/m3 to about 300 g/m3 azole, such as about 20 g/m3 to about 260 g/m3 azole, or a combination thereof. For instance, as shown in the examples, the present disclosure has found that the preservative composition is able to penetrate even to the core of the wood or cellulose-based product, and evenly distribute the preservative.

However, a wood or cellulose-based substrate may be treated with a ready to use preservative composition of the present disclosure. Such the wood or cellulose-based substrate may contain the copper containing biocide, zinc containing biocide, boric acid, and organic biocide in the amounts discussed above in regards to the ready to use composition.

The present disclosure is further directed to a method of manufacturing a wood preservative composition as well as treating a wood based substrate with said wood preservative composition. For instance, in one aspect, the copper containing biocide and the azole may be micronized (e.g. decreased in size from larger than micron size to the above discussed sizes/particle size distribution), together, or can instead be micronized separately and then combined, either alone, or in combination with one or more dispersants/complexing agents.

Furthermore, in one embodiment, the copper containing biocide, zinc containing biocide, boron containing biocide and organic biocide may be pre-mixed as discussed above. However, it should be understood that, the preservative composition may also be present in a multi-part form and mixed shortly before treating the wood or cellulose based substrate. However, in another embodiment, the preservative composition is in one-part form, such as a pack or mix, and contains each of the copper containing biocide, zinc containing biocide, boron containing biocide and organic biocide, in the amounts discussed above.

Regardless of the form of the wood preservative composition, said composition is diluted as discussed above, and used to treat a wood or cellulose based substrate. For instance, the application of the preservative composition of the present disclosure to the wood or cellulose based substrate may be by one or more of dipping, deluging, spraying, brushing, or other surface coating means or by impregnation methods, e.g., high pressure or double vacuum impregnation into the body of the wood or other material. In one aspect, the method is impregnation under pressure.

Furthermore, certain aspects of the present disclosure may be better understood according to the following examples, which are intended to be non-limiting and exemplary in nature.

### EXAMPLES

It will be understood that the preservative compositions described in the examples may be substantially free of any substance not expressly described.

### Abbreviations

| | |
|---|---|
| AWPA | American Wood Protection Association (AWPA) |
| BAE | Boric acid equivalent |
| BCC | Basic copper carbonate |
| SYP | Southern yellow pine |

### Methods

AWPA E10-16: “Laboratory Method for Evaluating the Decay Resistance of Wood-Based Materials Against Pure Basidiomycete Cultures: Soil/Block Test” This method is a screening test to determine the resistance of wood based materials to decay by selected fungi under controlled laboratory conditions. It can also be used to establish the minimum amount of preservative that is effective in preventing decay of selected species of wood by selected fungi under optimum laboratory conditions. This test method is intended to provide information for standardization of protection treatments. Blocks of wood are first conditioned via vacuum impregnation with a preservative solution. Typically, the blocks are submerged in the treating solution then exposed to vacuum treatment (30 min at 100 mmHg) followed by pressure treatment (60 min at 700 kPa) and 30 minute at atmospheric pressure. Test blocks should be cubes milled as accurately as possible to 14 mm or 19 mm, which yields a nominal volume of 2.7 cm³ or 6.9 cm³, respectively. After conditioning, the blocks of wood are exposed to wood-destroying fungi.

Particle size: The particle size was analyzed by Horiba LA-910 Particle Size Distribution Analyzer (PSDA).

### Example 1—AWPA E10-16 Soil/Block Test

Wood species: southern yellow pine (SYP)

Microorganisms: The following organisms are used in this study: Fibroporia radiculosa and Fomitopsis palustri. Fibroporia radiculosa (basidiomycete) and Fomitopsis palustri (basidiomycete) are brown rot fungi that have been documented to cause premature failure of wooden stakes treated with copper-based wood preservatives in the field, due to copper-tolerance.

Particle size: The particle size of the BCC, tebuconazole, zinc oxide was analyzed by Horiba LA-910 Particle Size Distribution Analyzer (PSDA). The average particle size of BCC, tebuconazole and zinc oxide was from 0.15 to 0.5 microns, with a D50 of 0.35 and a D95 of less tah 1 miron.

The soil block test was conducted following the procedure as described in AWPA E10-16. The test was performed on wood blocks treated via vacuum impregnation with a wood preservative composition of the present invention before and after leaching with above mentioned microorganisms.

The nature and ratio of the wood preservative composition is summarized in table 1. The ratio is expressed as weight % based on the total weight of the wood preservative composition. The leaching protocol was conducted following the procedure described in AWPA E10-16.

TABLE 1
Ratio of copper compound to active components in wood
preservative composition in weight % based on the
total weight of the wood preservative composition.

| Example | BCC:tebuconazole | BCC:ZnO | BCC:boric acid |
|---|---|---|---|
| 0 | 25:1 | | |
| 15 | 25:1 | | 0 |
| 17 | 25:1 | 6.7:1 | 2.4:1 |
| 18 | 25:1 | 13.4:1 | 4.7:1 |
| 22 | 0 | 0 | 0 |

Loss of mass of the wood block indicates the failure of a particular wood preservative composition to protect the wood against fungal attack. The retention level of a particular preservative corresponds to the minimum amount of preservative that protects the wood block against fungal decay. Calculation of Retentions was according to AWPA E10-16. The resulting weight loss data are summarized in Tables 2.

TABLE 2
AWPA E10-16 - Results retention and average weight loss that compare leached blocks to blocks not leached

| | total wood | Component Retention | | | | | | | |
|---|---|---|---|---|---|---|---|---|---|
| | preservative | in wood block | | | | Leached | | Not Leached | |
| | composition | Retained | Tebuconazoel | Zinc | Boric acid | F. radiculosa | F. palustris | F. radiculosa | F. palustris |
| | [kg/m³] | copper | retained | retained | retained | weight | Weight | weight | Weight |
| Example | Kg/m³ | [kg/m³] | [kg/m³] | [kg/m³] | [kg/m³] | loss [%] | loss [%] | loss [%] | loss [%] |
| 0 | 2.24 | 2.15 | 0.088 | | | | | 39.6 | |
| 15 | 2.40 | 2.31 | 0.092 | | | 47.1 | 23.9 | | |
| 15 | 3.36 | 3.23 | 0.129 | | | 49.0 | 23.5 | | |
| 17 | 3.71 | 2.31 | 0.092 | 0.345 | 0.963 | 45.8 | 13.1 | −1.2 | 15.8 |
| 17 | 5.19 | 3.23 | 0.129 | 0.482 | 1.35 | 41.9 | 15.8 | −1.1 | 19.0 |
| 18 | 3.15 | 2.31 | 0.092 | 0.172 | 0.578 | 44.1 | 17.8 | −1.7 | 28.7 |
| 18 | 4.29 | 3.23 | 0.129 | 0.241 | 0.687 | 35.4 | 14.3 | −1.7 | 23.9 |
| 22 | 0 | | | | | | | 52.5 | 41.5 |

In this test, both F. radiculosa and F. palustris were very active as indicated by untreated control average weight losses of 52.5% and 41.5% respectively. The wood preservative composition of the present invention proves to be highly efficient in protecting the impregnated blocks against decay by the given test fungus.

These and other modifications and variations to the present invention may be practiced by those of ordinary skill in the art, without departing from the spirit and scope of the present invention, which is more particularly set forth in the appended claims. In addition, it should be understood that aspects of the various aspects may be interchanged both in whole or in part. Furthermore, those of ordinary skill in the art will appreciate that the foregoing description is by way of example only, and is not intended to limit the invention so further described in such appended claims.

What is claimed:

1. A wood preservative composition comprising:
(a) a copper containing biocide;
(b) a zinc containing biocide;
(c) a boron containing biocide; and
(d) at least one organic biocide;

2. The wood preservative composition of claim 1, wherein the organic biocide is independently selected from the group consisting of azoles, quaternary ammonium compounds, isothiazolones, pyrazolecarboxamides, phenylpyrazoles, haloalkynyl compounds or a combination thereof.

3. The wood preservative composition of claim 1 or 2, wherein the copper containing biocide is independently selected from the group consisting of basic copper carbonate, a copper oxide, or a combination thereof.

4. The wood preservative composition of claim 1 or 2, wherein the zinc containing biocide is independently selected from the group consisting of zinc oxide, zinc acetate, zinc borate or a combination thereof.

5. The wood preservative composition of any one of claims 1-3, wherein the boron containing biocide is independently selected from the group consisting of boric acid, disodium tetraborate pentahydrate, disodium octoborate tetrahydrate, or combinations thereof.

6. The wood preservative composition of any one of claims 1-4, wherein the boron containing biocide is boric acid.

7. The wood preservative composition of any of the preceding claims wherein the organic biocide is an azole.

8. The wood preservative composition of any of the preceding claims wherein the organic biocide is a quaternary ammonium compound.

9. The wood preservative composition of any of the preceding claims wherein the organic biocide is penflufen.

10. The wood preservative composition of any of the preceding claims wherein the organic biocide is an isothiazolone.

11. The wood preservative composition of any one of claims 1-4, wherein the azole comprises a tebuconazole.

12. The wood preservative composition of any one of claims 1-5, wherein the azole comprises a tebuconazole, a propiconazole, or a mixture thereof.

13. The wood preservative composition of any one of claims 1-6, wherein the azole is complexed with the copper containing biocide.

14. The wood preservative composition of any one of claims 1-7, wherein the azole comprises micronized azole particles, wherein 50% or more of the micronized azole particles have a median particle size of less than about 1 micron.

15. The wood preservative composition of any one of claims 1-8, wherein the copper containing biocide comprises a basic copper carbonate; wherein the zinc containing biocide comprises a zinc oxide, zinc acetate, zinc borate or a combination of a zinc oxide and zinc borate; wherein the boron containing biocide comprises a boric acid; and wherein the azole comprises a tebuconazole.

16. The wood preservative composition of any one of claims 1-9, wherein the copper containing biocide constitutes from about 0.1 wt. % to about 75 wt. % based on the total weight of the composition; wherein the zinc containing biocide constitutes from about 0.1 wt. % to about 50 wt. % of the composition; wherein the boron containing biocide constitutes from about 0.1 wt. % to about 75 wt. % of the composition; and the organic biocide constitutes from about 0.1 wt. % to about 20 wt. % of the composition based on the total weight of the composition.

17. The wood preservative composition of any one of claims 1-10, wherein the composition has a pH of from about 3 to about 10.

18. The wood preservative composition of any one of claims 1-11, wherein the composition further comprises an alkanolamine.

19. The wood preservative composition of any one of claims 1-12, wherein the copper containing biocide and the zinc containing biocide are present in the wood preservative composition such that a weight ratio of copper to zinc is from about 15:1 to about 1:5 based on weight.

20. The wood preservative composition of any one of claims 1-13, wherein the copper containing biocide and the boron containing biocide are present in the wood preservative composition such that a weight ratio of copper to boron containing biocide is from about 15:1 to about 1:5 based on weight.

21. The wood preservative composition of any one of claims 1-14, wherein the zinc containing biocide and the boron containing biocide are present in the wood preservative composition such that a weight ratio of zinc to boron containing biocide is from about 5:1 to about 1:5.

22. The wood preservative composition of any one of claims 1-15, wherein the zinc containing biocide and the boron containing biocide are present in the wood preservative composition such that a weight ratio of zinc to boron containing biocide is from about 3:1 to about 1:1.5

23. A wood based product treated with the wood preservative composition of any one of claims 1-16.

24. A wood preservative composition comprising:
(a) a copper containing biocide;
(b) a zinc containing biocide;
(c) a boron containing biocide; and
(d) an organic biocide;
wherein the copper containing biocide and the zinc containing biocide are present in the wood preservative composition such that a ratio of copper to zinc is from about 15:1 to about 1:5 based on weight;
wherein the copper containing biocide and the boron containing biocide are present in the wood preservative composition such that a ratio of copper to boron containing biocide is from about 15:1 to about 1:5 based on weight;
wherein the copper containing biocide comprises a basic copper carbonate; wherein the zinc containing biocide comprises a zinc oxide or a combination of a zinc oxide and zinc borate; wherein the boron containing biocide comprises a boric acid; and wherein the azole comprises a tebuconazole.

25. A method of treating wood with the wood preservative composition of any one of claims 1-19, wherein the copper containing biocide, the zinc containing biocide, the boron containing biocide, and the at least one azole are injected into the wood in a one-step process.

26. A method for manufacturing a wood preservative composition, the method comprising:
(a) dispersing at least a portion of a copper containing biocide and a zinc containing biocide;
(b) micronizing at least one azole to produce a micronized azole; and
(c) combining a boron containing biocide comprising boric acid with the copper containing biocide, the zinc containing biocide, and the micronized azole:
wherein the copper containing biocide and the zinc containing biocide are present in the wood preservative composition a such that a ratio of copper ions to zinc ions is from about 15:1 to about 1:1
wherein the copper containing biocide and the boron containing biocide are present in the wood preservative composition such that a ratio of copper ions to boron containing biocide is from about 15:1 to about 1:5.

27. The method of claim 21, the method further comprising milling the copper containing biocide and the zinc containing biocide with at least one dispersant.

28. The method of any combination of claims 21 and 22, wherein the copper containing biocide constitutes from about 1 wt. % to about 75 wt. % of the composition; wherein the zinc containing biocide constitutes from about 0.1 wt. % to about 50 wt. % of the composition; wherein the boron containing biocide constitutes from about 0.1 wt. % to about 75 wt. % of the composition; and the azole constitutes from about 0.1 wt. % to about 20 wt. % of the composition based on the total weight of the composition.

29. The method of any one of claims 21-23, wherein the copper containing biocide comprises a basic copper carbonate; wherein the zinc containing biocide comprises a zinc oxide or a combination of a zinc oxide and a zinc borate; wherein the boron containing biocide comprises a boric acid; and the azole comprises a tebuconazole.
